(19) United States
(12) Patent Application Publication
(10) Pub. No.: US 2003/0197027 A1
(43) Pub. Date: Oct. 23, 2003

(54) MOP HANDLE ASSEMBLY ADAPTED TO DISPENSE LIQUID

(75) Inventor: John J. Dyer, Shoreview, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/127,942

(22) Filed: Apr. 23, 2002

(51) Int. Cl. B67D 5/64

(52) U.S. Cl. 222/175; 141/382

(57) ABSTRACT

A handle assembly and related kit for dispensing liquid to a surface. The handle assembly includes a handle, a valve system, and an actuator assembly. The valve system includes a delivery tube disposed within the handle that fluidly connects an upstream housing and a dispensing assembly. The upstream housing is fluidly connected to a liquid reservoir. The dispensing assembly includes a plunger forming at least one orifice. The actuator assembly biases the valve system toward a closed position in which the orifice is exteriorly sealed, and allows actuation to an open position in which the orifice is open relative to an exterior of the handle assembly. During use, the valve system is transitioned to the open position in which liquid flows from the reservoir to the orifice and outwardly therefrom without introducing air upstream of the orifice.

### BACKGROUND OF THE INVENTION

The present invention relates to a mop handle assembly. More particularly, it relates to a mop handle assembly simulating a conventional mop handle and providing a valve system adapted to dispense liquid from a remote reservoir.

Mops and similar implements are commonly used for applying finishes to, and/or cleaning, surfaces in a wide variety of environments. In its most basic form, the typical mop includes an elongated handle (normally wood or plastic) attached to a mop head. As used throughout this specification, the term “mop head” is in reference to a number of known finishing and/or cleaning heads, including a string-type mop, flat mop, sponge, squeegee, broom, etc. With this definition in mind, for most applications, the mop head is soaked with one or more liquids. For example, a user may employ the mop head to apply an appropriate liquid to a floor surface (for example wax, cleaning liquid, disinfectant, and the like). Alternatively, or in addition, water may be used to periodically rinse or clean collected debris from the mop head. In this regard, the necessary liquid(s) are contained within one or more buckets that the user must transport with him/her while performing the finishing/cleaning task. Obviously, this presents a distinct inconvenience for the user. Further, inadvertent liquid spillage may occur during the frequent dipping of the mop head into the bucket(s).

Numerous efforts have been made to develop a combination mop assembly/liquid dispenser that overcomes the problems identified above. Prior mop assembly/liquid dispensement devices are typically characterized by having a look and feel that is quite different from a normal mop handle. One approach entails a liquid container mounted directly onto the mop handle in conjunction with a valve system that provides control over liquid flow to the mop head. When filled with liquid, the attached container renders the mop handle quite cumbersome to maneuver. Alternatively, the handle itself has been designed to internally contain the liquid. While eliminating the unwieldy external container, the device must carry a relatively large volume of liquid within the handle, again rendering normal use difficult. Further, inherent handle size constrains may limit the available liquid volume capacity below a useful level. Finally, other approaches entail strapping a pressurized liquid container to the user's back. The corresponding valve system and fluid delivery components are complex and do not comport with the look and feel of a standard mop handle.

The negative implications associated with a mop handle assembly that looks and/or feels differently from the standard design cannot be underestimated. Workers in the floor finishing and maintenance industry typically become highly proficient at their jobs using a standard mop. While they may be more than willing to accept new finishing or cleaning liquids, they are much less inclined to even try a new mop device that looks or feels different from what that are comfortable using. Thus, though the above-described devices may present distinct advancements, they are of limited value from a marketing standpoint.

A related concern is product cost. Once again, the standard mop design in which a mop head is attached to a wood or plastic handle is highly inexpensive. Prior mop handle/liquid dispensement devices typically incorporate a relatively complex valving system to regulate liquid flow. These valving systems render the devices relatively expensive. Thus, from a cost standpoint, prior techniques present a distinct obstacle to market acceptance.

A further concern associated with prior combination mop handle/liquid dispensers is that the respective valving mechanisms cannot ensure that liquid flow to the mop head will cease upon the user's command. In general terms, prior delivery techniques employ an elongated tube having an inlet connected to the valve and an outlet positioned to dispense liquid. When the valve is open, liquid flows from the inlet to the outlet, and outwardly therefrom. Movement of the valve to a closed position will seal the inlet. However, the outlet remains open so that liquid may unexpectedly continue to flow or drip from the outlet.

The floor surface finishing and cleaning industry continues to rely upon mops and related finishing/cleaning liquids. While attempts have been made to directly connect a liquid container and dispensement system to a conventional mop handle, market success, if any, has been limited due to cost, lack of user acceptance, poor performance, etc. Therefore, a need exists for a mop handle device that looks and feels highly similar to a standard mop handle, provides complete control over liquid flow on a cost effective basis, and overcomes one or more of the disadvantages previously described.

### SUMMARY OF THE INVENTION

One aspect of the present invention relates to a handle assembly for dispensing liquid from a remote liquid reservoir. The handle assembly includes a handle, a valve system, and an actuator assembly. The handle defines an upper end, a lower end, and an internal passage. The valve system includes an upstream housing, a dispensing assembly, and a delivery tube. The upstream housing is associated with the upper end of the handle and defines an inlet adapted to be fluidly connected to a remote liquid reservoir. The dispensing assembly is associated with the lower end of the handle and includes a plunger defining a central passage fluidly connected to at least one orifice. The delivery tube is disposed within the internal passage of the handle and fluidly connects the upstream housing to the plunger. Finally, the actuator assembly is configured to bias the valve system toward a closed position in which the orifice is sealed relative to an exterior of the dispensing assembly so that liquid cannot be dispensed therefrom. Further, the actuator assembly is configured to allow selective actuation of the valve system to an open position in which the orifice is not sealed relative to an exterior of the dispensing assembly. In this regard, the valve system permits flow of liquid from the upstream housing to the orifice in the open position without introduction of air upstream of the orifice. In one preferred embodiment, the handle assembly further includes a mop head-coupling device associated with the handle adjacent the lower end for selectively receiving a mop head. In this regard, the mop head can be a string mop, a flat mop, a sponge mop, a squeegee, or a broom.

Another aspect of the present invention relates to a mop kit including a handle assembly and a liquid supply reservoir. The handle assembly includes a handle, a supply tube, a valve system, and an actuator assembly. The handle defines an upper end, a lower end, and an internal passage. The valve system includes an upstream housing, a dispensing assembly, and a delivery tube. The upstream housing is associated with the upper end of the handle and defines an inlet and an outlet. The inlet is fluidly connected to an end of the supply tube. The dispensing assembly is associated with the lower end of the handle and includes a plunger defining a central passage fluidly connected to at least one orifice. The delivery tube is disposed within the handle and fluidly connects the upstream housing to the plunger. The actuator assembly biases the valve assembly toward a closed position in which the orifice is sealed relative to an exterior of the dispensing assembly. Further, the actuator assembly is configured to allow selective actuation of the valve system to an open position in which the orifice is not sealed relative to an exterior of the dispensing assembly. Finally, the liquid supply reservoir is fluidly connected to the first end of the supply tube. In this regard, the liquid supply reservoir is positioned remote of the handle. With this configuration, the valve system is adapted to permit flow of liquid from the liquid supply reservoir to the orifice in the open position without introduction of air upstream of the orifice. In one preferred embodiment, the liquid supply reservoir includes a flexible, collapsible bag containing a volume of liquid.

### BRIEF DESCRIPTION OF THE DRAWINGS

FIG. 1 is a perspective view of a mop kit including a mop handle assembly in accordance with the present invention;

FIG. 2 is an exploded, side view of the mop handle assembly of FIG. 1;

FIG. 3A is a cross-sectional view of the mop handle assembly of FIG. 2 in a closed position;

FIG. 3B is an exploded, perspective view of a lower portion of the mop handle assembly of FIG. 3A in conjunction with a mop head device;

FIG. 4A is a cross-sectional view the mop handle assembly of FIG. 2 in an open position;

FIG. 4B is a perspective view of a lower portion of the mop handle assembly of FIG. 4A assembled to a mop head device;

FIG. 5 is an exploded, side view of a preferred valve assembly for connecting a supply to a portion of the mop handle assembly of FIG. 2 with a liquid reservoir;

FIG. 6 is a cross-sectional view of the valve assembly of FIG. 5 upon final assembly; and

FIG. 7 is an enlarged, perspective view of a preferred liquid reservoir useful with the mop handle assembly of FIG. 2.

### DETAILED DESCRIPTION OF THE PREFERRED EMBODIMENTS

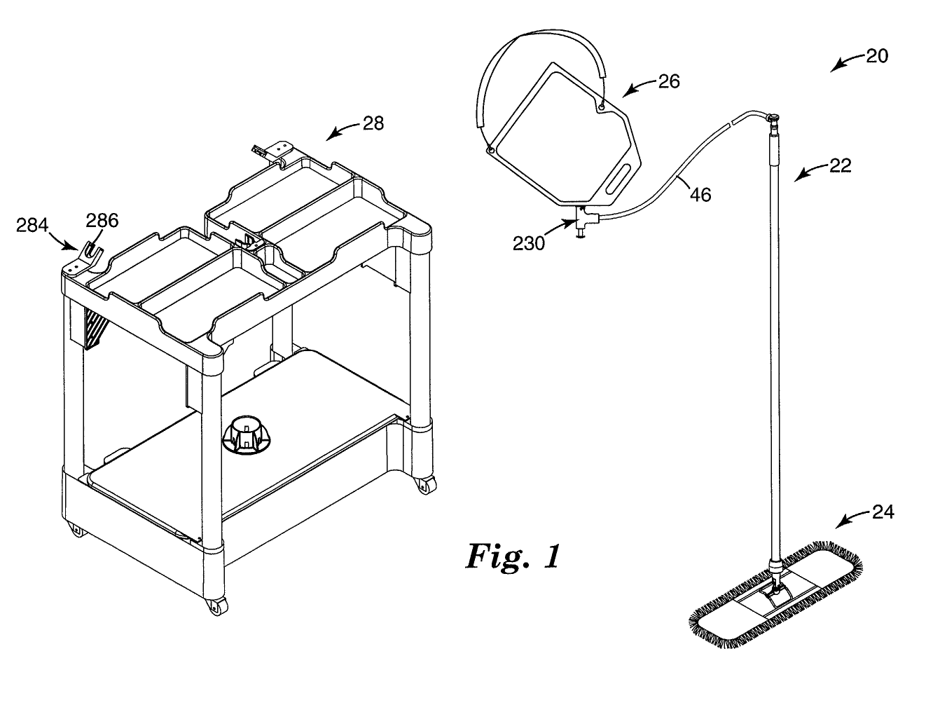

One preferred embodiment of a mop kit 20 including a mop handle assembly 22 in accordance with the present invention is shown in FIG. 1. In addition to the mop handle assembly 22, the kit 20 preferably includes a mop head 24, a liquid reservoir 26, and a cart 28. The various components are described in greater detail below. In general terms, however, the mop head 24 is removably connected to the mop handle assembly 22. The mop handle assembly 22, in turn, is fluidly connected to the liquid reservoir 26. Finally, the cart 28 is preferably provided for conveniently storing and transporting the mop handle assembly 22, the mop head(s) 24, and the liquid reservoir(s) 26.

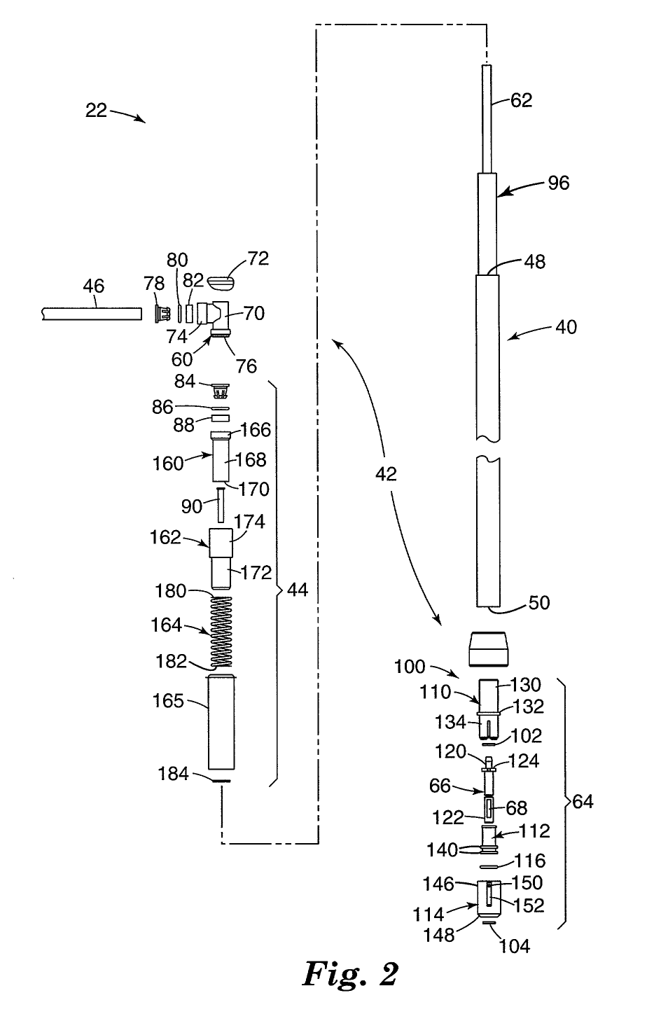

The mop handle assembly 22 is shown in greater detail in FIG. 2. The mop handle assembly 22 preferably includes a handle 40, a valve system (referenced generally at 42), an actuator assembly 44, and a supply tube 46. In general terms, the valve system 42 is connected to the handle 40, and is fluidly connected to the supply tube 46. The actuator assembly 44 is associated with the valve system 42, and is configured to facilitate selective actuation of the valve system 42 from a closed position to an open position. In the closed position, the valve system 42 is sealed relative to an exterior of the mop handle assembly 22, such that liquid from the liquid reservoir 26 (FIG. 1) is not released from the valve system 42. Conversely, in the open position, the valve system 42 allows liquid to flow from the liquid reservoir 26 to an exterior of the mop handle assembly 22.

The handle 40 can assume a variety of forms, but it is preferably an elongated tube formed from a material commonly employed for mop handles. Thus, in a preferred embodiment, the handle 40 is highly similar to existing, “standard” mop handles in look and feel, and is preferably formed from an appropriate material such as a composite fiberglass. Alternatively, other materials such as wood, aluminum, and the like are equally acceptable. Further, the handle 40 can assume a variety of dimensions, but preferably has an outer diameter that is approximately the same size as a “standard” mop handle, and is thus on the order of 2.54 cm (1 inch). A length of the handle 40 can also vary depending upon a particular application, but is preferably in the range of 120-152 cm (48-60 inches). For example, the handle 40 can be relatively long (for example, on the order of 152 cm (60 inches)) for floor surface finishing/cleaning applications, or relatively short (for example, on the order of 120 cm (48 inches)) for confined area finishing/cleaning applications such as cleaning toilets, urinals, etc. The handle 40 has an upper end 48 and a lower end 50.

The valve system 42 includes an upstream housing 60, a delivery tube 62, and a dispensing assembly 64. The components 60-64 are described in greater detail below. In general terms, however, the delivery tube 62 is disposed within the handle 40. The upstream housing 60 is associated with the upper end 48 of the handle 40 and is fluidly connected to the delivery tube 62. Further, the upstream housing 60 is adapted to be fluidly connected to a remote liquid reservoir (such as the liquid reservoir 26 of FIG. 1). Conversely, the dispensing assembly 64 is associated with the lower end 50 of the handle 40, and is fluidly connected to the delivery tube 62. In this regard, the dispensing assembly 64 includes a plunger 66 forming at least one orifice 68. As described in greater detail below, in the closed position, the plunger 66 is positioned within the dispensing assembly 64, such that the orifice 68 is exteriorly sealed. Conversely, in the open position, the plunger 66 is extended, thereby exteriorly exposing the orifice 68 and allowing fluid flow from the upstream housing 60 outwardly through the orifice 68.

In one preferred embodiment, the upstream housing 60 includes an elbow piece 70 and a button 72. The elbow piece 70 is tubular in nature and defines an inlet 74 and an outlet 76. The inlet 74 is configured to be fluidly connected to the liquid reservoir 26 (FIG. 1), preferably via the supply tube 46. In this regard, a grip 78, an O-ring 80, and a receiving clasp 82 are preferably provided. As is known in the art, the grip 78, the O-ring 80, and the retention clasp 82 serve to fluidly connect the supply tube 46 to the inlet 74 of the elbow piece 70. Alternatively, other fluid connection techniques are equally acceptable.

The outlet 76 of the elbow piece 70 is similarly adapted for fluid connection to the delivery tube 62. For example, in one preferred embodiment, a grip 84, an O-ring 86, and a retention clasp 88 are provided. These components 84-86, preferably in conjunction with a support tube 90, fluidly connect the outlet 76 to the delivery tube 62. Alternatively, other fluid connection techniques known in the art are equally acceptable. Preferably, however, the connection between the elbow piece 70 and the delivery tube 62 is such that the elbow piece 70 can be rotated relative to the handle 40. That is to say, upon final assembly, the elbow piece 70 preferably extends from the upper end 48 of the handle 40, and can be rotated relative thereto. In this way, then, a user (not shown) can conveniently position the elbow piece 70 at any rotational position relative to the handle 40 (and thus relative to the mop head 24 (FIG. 1) secured thereto).

As described below, during use, the elbow piece 70 is depressed relative to the handle 40 to effectuate actuation of the valve assembly 42 from the closed position to the open position. In this regard, the upstream housing 60 preferably includes the button 72 formed along the elbow piece 70. The button 72 provides a convenient surface for receiving a user's thumb for effectuating desired depression of the elbow piece 70, with the elbow piece 70 and the button 72 effectively combining to form a trigger. Thus, the button 72 can assume a wide variety of forms, or where desired, can be eliminated entirely. In one preferred embodiment, however, the elbow piece 70 and the button 72 are integrally formed as a unitary component, preferably molded plastic.

The delivery tube 62 is an elongated body sized for placement within the tubular handle 40. As described below, the delivery tube 62 is configured to translate a force on the upstream housing 60 to the dispensing assembly 64, and as such, is preferably made of a relatively rigid material such as high density polyethylene (HDPE). Alternatively, other materials such as polyurethane are also acceptable. In one preferred embodiment, the delivery tube 62 is slidably nested within the handle 40 via a core 96 that prevents side-to-side displacement of the delivery tube 62 during operation of the valve system 42. In a preferred embodiment, the core 96 is formed of HDPE or polypropylene, although other materials are equally acceptable. Alternatively, the delivery tube 62 can be unsupported within the handle, such that the core 96 is eliminated.

The dispensing assembly 64 preferably includes the plunger 66, a downstream housing 100 (referenced generally in FIG. 2), a first seal 102, and a second seal 104. The plunger 66 is fluidly connected to the delivery tube 62 and is slidably disposed within the downstream housing 100. The downstream housing 100, in turn, is connected to the lower end 50 of the handle 40. Finally, the first and second seals 102, 104 are positioned to fluidly seal the plunger 66 relative to the downstream housing 100, as described in greater detail below.

The plunger 66 is a tubular body in which the at least one orifice 68 is defined, and includes an upstream portion 120 and a downstream portion 122. Though hidden in FIG. 2, a central passage is formed in the plunger 66 that fluidly connects an opening at the upstream portion 120 with the orifice 68. The upstream portion 120 is adapted to be fluidly connected to the delivery tube 62, and preferably forms a shoulder 124 that promotes a desired assembly position of the plunger 66 relative to the delivery tube 62. The downstream portion 122 is closed downstream of the orifice 68. As such, liquid entering the plunger 66 at the upstream portion 120 exits therefrom via the orifice 68. The embodiment of FIG. 2 illustrates the plunger 66 as forming one orifice 68. Preferably, however, two orifices 68 are formed, equidistantly spaced about a circumference of the plunger 66. Alternatively, any other number of orifices 68 can be provided.

In one preferred embodiment, the downstream housing 100 includes a sleeve 110, a spool 112, a bottom 114, and an O-ring 116. In general terms, the plunger 66 is slidably maintained within the bottom 114 by the sleeve 110 and the spool 112. The O-ring 116 fluidly seals the downstream housing 100 relative to an exterior thereof.

The sleeve 110 is a tubular body sized to slidably receive the plunger 66, and preferably forms a head 130, a flange 132, and a trailing section 134. The head 120 is sized to be frictionally received within the handle 40. In this regard, the flange 132 serves as a stop, abutting the lower end 50 of the handle 40 upon final assembly. Finally, the trailing section 134 is configured for attachment to the bottom 114.

The spool 112 is a tubular body sized to slidably receive the plunger 66. Further, the spool 112 is sized to be received within the bottom 114. In this regard, the spool 112 preferably includes opposing flanges 140 that are adapted to maintain the O-ring 116. With this one preferred construction, then, the spool 112 is fluidly sealed to the bottom 114 via the O-ring 116 upon final assembly.

The bottom 114 is a cup-shaped body having an upstream section 146 and a downstream section 148. The upstream section 146 forms an internal passage (not shown) sized to receive the spool 112 as previously described. The downstream section 148 forms a central hole (not shown) sized to allow slidable passage of the plunger 66 as described below. In general terms, as the valve system 42 is transitioned from a closed position to an open position, the plunger 66 is extended through the central hole in the bottom 114, exposing the at least one orifice 68. In a preferred embodiment, the bottom 114, and in particular, the upstream section 146, is sized to encompass the spool 112 and the trailing section 134 of the sleeve 110 upon final assembly. In this regard, the bottom 114 is preferably configured to be mounted to the sleeve 110 via a set screw 150. Alternatively, other mounting techniques are equally acceptable. Finally, in one preferred embodiment, the upstream section 146 of the bottom 114 forms alignment arms or keys 152 (one of which is shown in FIG. 2) along an exterior thereof. The alignment arms 152 are sized to receive a mop head (such as the mop head 24 in FIG. 1) and orientate the mop head at a desired position relative to the plunger 66, and in particular the orifices 68. This preferred relationship is described in greater detail below. Alternatively, however, where an orientation of the mop head relative to the plunger 66 is of less concern, the alignment arms 152 can be eliminated.

The first and second seals 102, 104 provide fluid seals for the plunger 66 upstream and downstream of the orifices 68. In particular, in the closed position, the at least one orifice 68 must be sealed relative to the mop handle assembly 22 both upstream and downstream of the orifices 68. In this regard, the first seal 102 serves as an upstream seal, and is secured to the plunger 66 upstream of the orifices 68. At this desired position, the first seal 102 fluidly seals the plunger 66 relative to the sleeve 110. Conversely, in at least the closed position, the second seal 104 serves as a downstream seal for the orifices 68. More particularly, the second seal 104 is secured to the bottom 114 adjacent the central hole (not shown) formed therein, and is positioned to slidably receive the plunger 66. In the closed position, the second seal 104 is downstream of the orifice(s) 68, such that the orifice(s) 68 is sealed relative to an exterior of the mop handle assembly 22, and in particular the dispensing assembly 64 (for example the bottom 114). Conversely, in the open position, the downstream portion 122 of the plunger 66 is extended beyond the bottom 114 such that the orifice(s) 68 is downstream of the second seal 104. Thus, the second seal 104 does not seal the orifice(s) 68 relative to an exterior of the dispensing assembly 64. In a preferred embodiment, the sealed, sliding relationship of the plunger 66 relative to the sleeve 110 and the bottom 114 is accomplished by forming the first and second seals 102, 104 as lip seals. In general terms, a lip seal is similar to an O-ring, but is “C” shaped in cross-section. With this one preferred configuration, the first and second seals 102, 104 do not overtly impede sliding movement of the plunger 66 from the closed position to the open position so that a user will not become fatigued when operating the valve system 42. However, other sealing devices or configurations known in the art can be employed.

The actuator assembly 44 biases the valve system 42 to the closed position, and is configured to facilitate manual transition of the valve system 42 to the open position. With this in mind, and in one preferred embodiment, the actuator assembly 44 includes a collet 160, a sleeve 162, a spring 164, and an outer grip member 165. Generally speaking, the collet 160 maintains the elbow piece 70, and engages the spring 164. The sleeve 162 slidably retains the collet 160 and the spring 164 relative to the handle 40. The outer grip member 165 encloses the sleeve 162 relative to the handle 40.

The collet 160 is a tubular body including a head 166 and a neck 168. The head 166 is configured for attachment to the elbow piece 70, such as by a snap-fit. The neck 168 is sized to be slidably received within the sleeve 162. Further, a trailing end 170 of the neck 168 is sized to contact the spring 164 as described below. In this regard, a force provided by the spring 164 is translated to the elbow piece 70 via the collet 160, and vice-versa. Thus, the collet 160 is preferably formed of a rigid material such as nylon or acetal. Alternatively, other materials such as polypropylene are acceptable.

The sleeve 162 is a tubular body configured to receive the neck 168 of the collet 160, as well as the spring 164. Further, the sleeve 162 is preferably configured to be mounted to the upper end 48 of the handle 40, preferably via a foot 172. In this regard, the sleeve 162 preferably further forms a head 174 that defines an outer diameter corresponding with an outer diameter of the handle 40. With this one preferred configuration, upon final assembly, the handle 40 and the sleeve 162 define a relatively contiguous outer surface.

The spring 164 is preferably a compression spring as known in the art and includes a first end 180 and a second end 182. The first end 180 is sized to abut the trailing end 170 of the collet 160 upon final assembly. Conversely, the second end 182 is configured to rigidly engage a portion of the handle 40 upon final assembly. In one preferred embodiment, the second end 182 engages the core 96 via a washer 184. As described in greater detail below, the spring 164 is sized to be received within the sleeve 162, and biases the collet 160 to the closed position. A downward force applied to the elbow piece 70 is transmitted through the collet 160 and onto the spring 164. As the force of the spring 164 is overcome, the elbow piece 70 is translated downwardly to the open position. Alternatively, other actuator designs are acceptable.

Finally, the outer grip member 165 is a thin-walled, tubular body sized to fit over the sleeve 162 and the handle 40. In one preferred embodiment, the outer grip member 165 is formed of a conformable, rubber-like material, such as vinyl, so that the grip member 165 is tight about the sleeve 162 and the handle 40, and provides a convenient surface for grasping by a user. Further, the outer grip member 165 serves to render the mop handle assembly 22 more aesthetically pleasing in that internal components of the valve system 42 and/or the actuator assembly 44 are not readily seen.

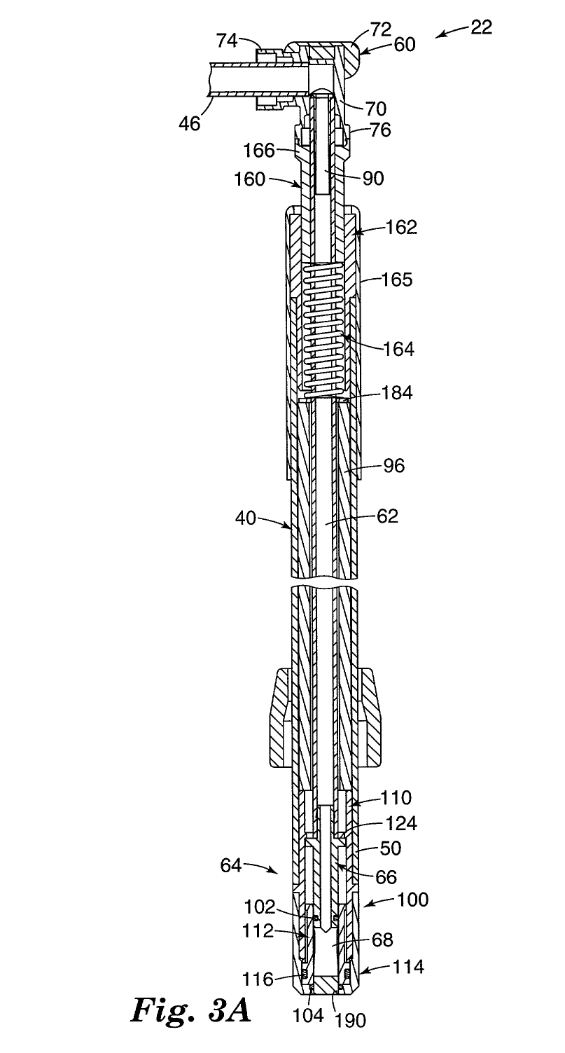

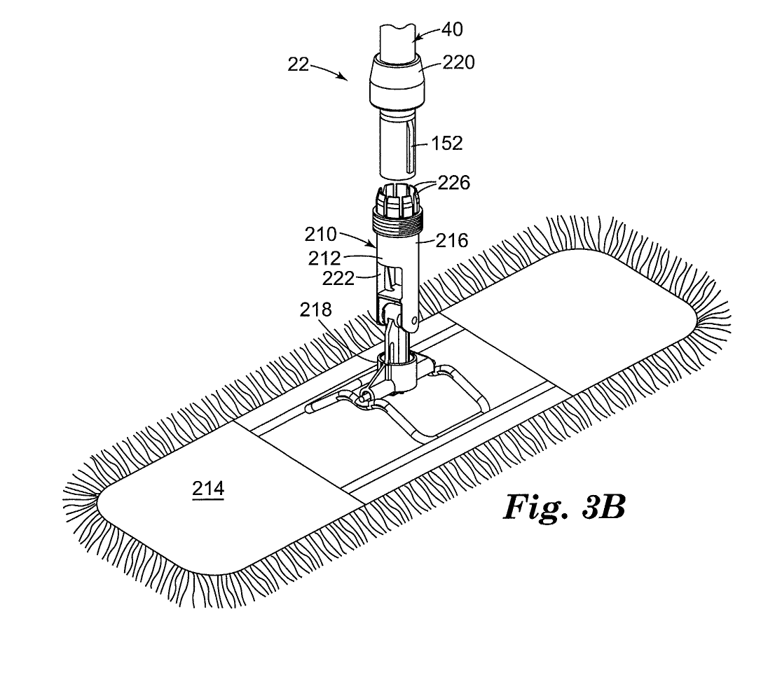

Final construction of the mop handle assembly 22 is provided in FIG. 3A. As a point of reference, the mop handle assembly 22 is shown in the closed position in FIG. 3A. With this in mind, the delivery tube 62 is disposed within the handle 40 and, where provided, the core 96. The support tube 90 is fluidly connected to the delivery tube 62. The washer 184 and the spring 164 are assembled over the delivery tube 62. The sleeve 162 is received over the spring 164. The collet 160 is slidably secured within the sleeve 162. The elbow piece 70 is secured to the head 166 of the collet 160, with the outlet 76 being fluidly connected to the delivery tube 62 via the support tube 90 and related components 84-88 (FIG. 2; not shown in the view of FIG. 3A). Finally, the outer grip member 165 is disposed over the sleeve 162 and an upper portion of the handle 40.

The dispensing assembly 64 is assembled to the delivery tube 62 opposite the upstream housing 60. In particular, the sleeve 110 is secured to the lower end 50 of the handle 40. The plunger 66 is fluidly connected to the delivery tube 62, and is slidably disposed within the sleeve 110. In this regard, the first seal 102 seals the plunger 66 relative to the sleeve 110. The spool 112 is assembled over the plunger 66. The bottom 114 is then assembled over the spool 112 and the trailing section 124 of the sleeve 110. In this regard, the second seal 104 fluidly seals the plunger 66 relative to the bottom 114. Further, the O-ring 116 seals the spool 112 relative to the bottom 114. As shown in FIG. 3A, in the closed position, the plunger 66 is positioned such that the at least one orifice 68 is within the bottom 114, and is fluidly sealed relative to an exterior of the bottom 114 (and thus of the dispensing assembly 64) via the second seal 104. Conversely, the first seal 102 fluidly seals the at least one orifice 68 upstream thereof relative to the sleeve 110. As such, liquid that might otherwise flow through the orifice 68 is sealed within the downstream housing 100 via the first and second seals 102, 104. Thus, as shown in FIG. 3A, in the closed position, the central hole 190 otherwise defined by the bottom 114 is sealed relative to the orifices 68, such that no liquid can flow therethrough.

Additionally, FIG. 3B provides an exploded illustration of a portion of the handle assembly 22 in conjunction with a mop head device 210. In general terms, the mop head assembly 210 includes a frame 212 and a mop head 214. The frame 212 and the mop head 214 can be provided as a singular device. Alternatively, the mop head 214 can be an item provided separate from the frame 212, with the frame 212 forming part of the mop handle assembly 22. The frame 212 generally includes an upper portion 216 and a lower portion 218. The lower portion 218 is adapted to receive the mop head 214. The upper portion 216 is adapted to be mounted to the handle 40, preferably by a coupling device 220 otherwise retained along an exterior of the handle 40. For example, in one preferred embodiment, the coupling device 220 is an interiorly threaded nut slidably received over the handle 40, and is provided as a component of the mop handle assembly 22. Regardless, the upper portion 216 forms a channel 222 sized to allow passage of the plunger 66 in the open position as described below. In a preferred embodiment, the upper portion 216 further includes a plurality of spaced fingers 226 adapted to receive the alignment arms 152 at a desired rotational position of the frame 212 relative to the handle 40, as described in greater detail below.

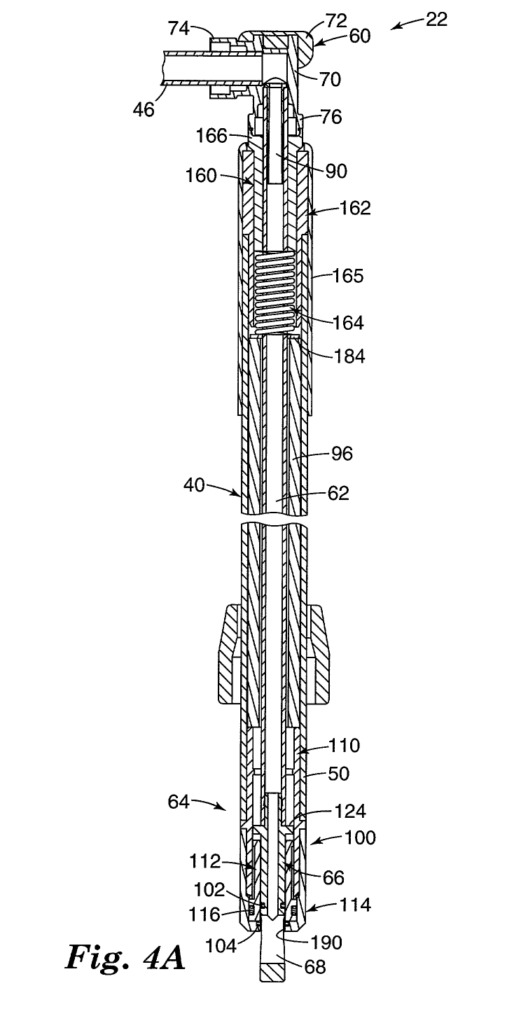

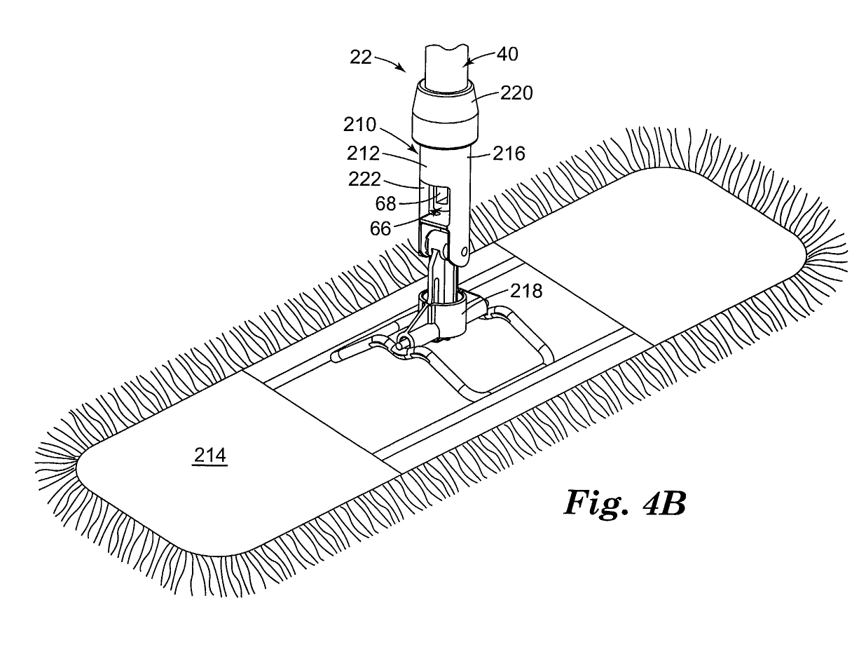

The mop handle assembly 22 is shown in the open position in FIG. 4A. In particular, when dispensement of liquid from the liquid reservoir 26 (FIG. 1) to the mop head 214 (FIG. 3B) is desired, a user (not shown) depresses the elbow piece 70 relative to the handle 40. In this regard, the preferred grip 165 affords the user the ability to readily grasp the mop handle assembly 22, while using his or her thumb to press down on the elbow piece 70. The downward force overcomes the bias of the spring 164 (as otherwise translated to the elbow piece 70 via the collet 160), such that the elbow piece 70 moves downwardly, or toward the handle 40. This downward movement is translated through the delivery tube 62 to the plunger 66. The plunger 66, in turn, is extended outwardly through the central hole 190 in the bottom 114, thereby exposing the orifice(s) 68. As best shown in FIG. 4B, then, in the open position, liquid from the liquid reservoir 26 (FIG. 1) is fed, via gravity, through the supply tube 46 to the elbow piece 70, through the delivery tube 62, and then to the plunger 66. Because the orifice(s) 68 is no longer sealed relative to the downstream housing 100, liquid flows outwardly from the orifice(s) 68. This liquid flow from the upstream housing 60 (FIG. 4A) to (and through) the orifice(s) 68 occurs without introduction of air upstream of the orifice(s) 68. Thus, the mop handle assembly 22 achieves desired liquid flow and dispensement without an external air pressure source (it being understood that air could, in theory, enter the orifice(s) 68 in the open position; however, this air would not be utilized to induce liquid flow or dispensing).

In one preferred embodiment, the frame 212 of the mop head device 210 is oriented such that the preferred two orifices 68 are positioned within the channel 222, thereby distributing liquid both in front and behind the mop head 214 in one preferred embodiment, alternatively to opposing sides of the mop head 214. Notably, by preferably dispensing liquid in front of the mop head 214, a user can visually confirm liquid flow, as well as an overall volume dispensed. In this regard, the alignment arms 152 (FIG. 3B) associated with the bottom 114 dictate a desired position of the frame 212 relative to the plunger 66, and in particular the orifices 68, via engagement with the fingers 226 (FIG. 3B). For example, during a floor surface finishing/cleaning operation, a user will naturally hold the handle 40 at a rotational orientation that results in a desired orientation of the mop head 214 (for example orienting the mop head 214 to facilitate a natural, back-and-forth sweeping motion). Once held in this position, the handle 40 effectively defines a forward side (away from the user) and a rearward side (toward the user). The preferred alignment arms 152/fingers 226 ensure that the mop head 214 is rotatably oriented relative to the handle 40 such that in the open position, the plunger 66 positions the orifices 68 within the channel 222 for unimpeded liquid dispensement, with liquid being dispensed in a pre-determined direction relative to the so-defined forward side and rearward side of the handle 40 and the mop head 214. For example, with the arrangement of FIG. 4B, the channel 222 and orifices 68 are oriented in a predetermined fashion (via interaction of the alignment arms 152 and the fingers 226) to distribute liquid at opposing sides of the handle 40 and the mop head 214 (perpendicular to the forward and rearward sides). Alternatively, interaction between the preferred alignment arms 152 and fingers 226 can dictate an orientation of the channel 222 and the orifices 68 that results in liquid being dispensed at the forward side and rearward side of the handle 40 (and thus the mop head 214) . Once the downward force on the elbow piece 70 is removed (the user releases the elbow piece 70), the spring 164 biases the elbow piece 70 back to the closed position, via the collet 160, as shown in FIGS. 3A and 3B.

The mop head assembly 22 of the present invention is relatively inexpensive, and easy to use. In this regard, because the handle 40 is preferably virtually identical in terms of size and appearance, to existing mop handle designs, the mop handle assembly 22 will be readily accepted by most floor finishing/cleaning operators who are otherwise comfortable with “standard” mop handles. Further, the mop handle assembly 22 seals the orifices 68 relative to the downstream housing 100 in the closed position such that unexpected liquid flow will not occur. Finally, the valve system 42 is configured to dispense liquid from the reservoir 26 (FIG. 1) in the open position without the introduction of air upstream of the orifices 68. This preferred feature greatly enhances the user's control over desired liquid dispensement.

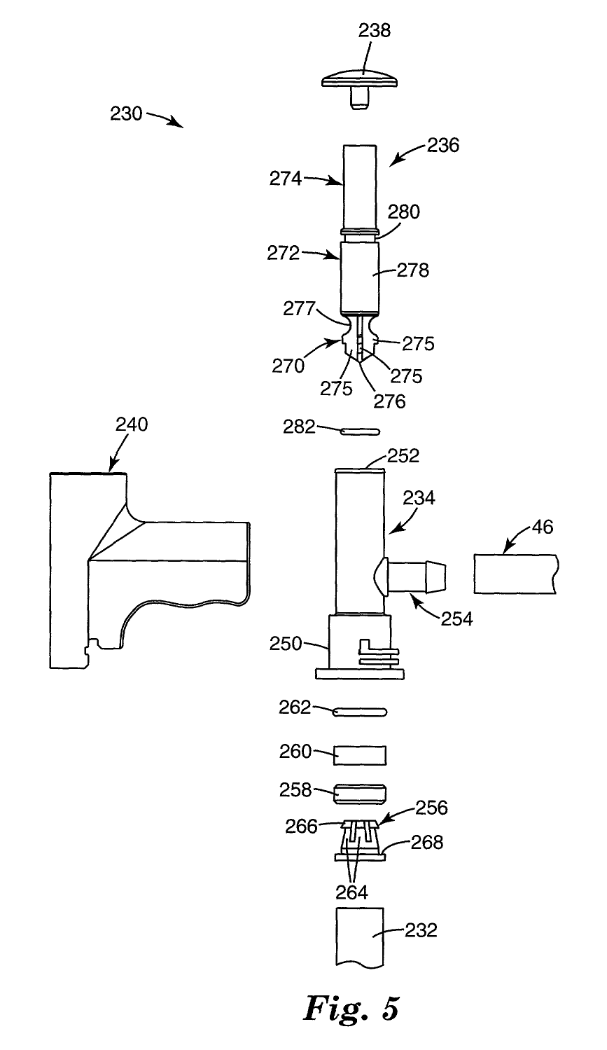

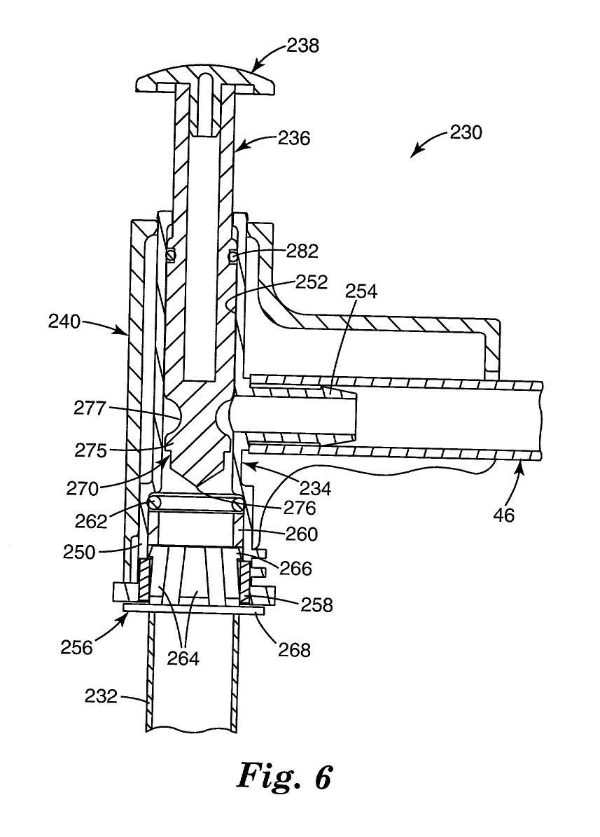

As previously described, the mop handle assembly 22 is configured to dispense liquid from a wide variety of reservoir designs via the supply tube 46. To this end, and in one preferred embodiment, the mop handle assembly 22 further includes a supply valve device 230 that is fluidly connectable to the supply tube 46 as shown in FIGS. 5 and 6. The supply valve device 230 is adapted to consistently fluidly couple the supply tube 46 to an outlet 232 (shown generally in FIGS. 5 and 6) otherwise associated with the liquid reservoir 26 (FIG. 1). In this regard, the supply valve device 230 is preferably a “quick release” valve, and includes a coupler body 234, a plunger 236, a button 238, and a handle 240. As described in greater detail below, the coupler body 234 is adapted to fluidly receive the supply tube 46, as well as the outlet 232 associated with the liquid reservoir 26. The plunger 236, in conjunction with the button 238, selectively connects the coupler body 234 to the outlet 232. Finally, the handle 240 encompasses at least the coupler body 234, and provides a convenient surface for user handling.

The coupler body 234 is a T-shaped tubular member defining an inlet region 250, a passageway 252 (referenced generally in FIG. 5, shown in greater detail in FIG. 6), and an outlet port 254. The coupler body 234 fluidly connects each of the inlet regions 250, the passageway 252, and the outlet port 254. Further, the inlet region 250 is axially aligned with the passageway 252, and forms a compartment for maintaining connection components, preferably including a grip 256, a ring 258, a spacer 260, and an O-ring 262. The grip 256 includes arms 264 each terminating in a radially outwardly extending foot 266. An inner diameter defined by the arms 264 is sized to frictionally receive the outlet 232. Further, an outer diameter defined by the arms 264 is sized to be received within the ring 258. Conversely, the feet 266 combine to define an outer diameter greater than an inner diameter of the ring 258. In this regard, each of the arms 264 are circumferentially spaced from one another, such that the arms 264 can be deflected radially inwardly. Finally, the grip 256 forms a lip 268 opposite the feet 266. With this construction, and as best shown in FIG. 6, the ring 258 can be assembled over the grip 256, and in particular the arms 264, by inwardly deflecting the arms 264 such that the ring 258 passes over the feet 266. As the arms 264 return to an unloaded position, the ring 258 is captured relative to the grip 256 between the feet 266 and the lip 268. The ring 258, in turn, is frictionally secured within the inlet region 250. In this regard, the assembled grip 256/ring 258 are maintained at a desired position within the inlet region 250 by the spacer 260 and the O-ring 262. The O-ring 262 further provides a seal between the coupler body 234 and the plunger 236 as described below.

The plunger 236 includes a leading end 270, an intermediate portion 272, and a trailing end 274. The leading end 270 preferably includes radially extending fingers 275 that taper to a pointed tip 276 for piercing a membrane (not shown) otherwise associated with the outlet 232. A neck 277 is defined above the fingers 275 that, in combination with a spacing between the fingers 275, establishes a liquid flow region in the leading end 270. The intermediate portion 272 is sized to be slidably received within the coupler body 234 via the passageway 252. In this regard, the intermediate portion 272 includes a forward region 278 having an outer diameter approximating an inner diameter of the O-ring 262. With this preferred construction, the forward region 278 will fluidly seal against the O-ring 262 when the plunger 236 is fully inserted within the coupler body 234. Additionally, the intermediate portion 272 forms an annular groove 280 sized to receive an O-ring 282 that serves to fluidly seal the plunger 236 relative to the coupler body 234 between the outlet port 254 and the passageway 252 such that fluid cannot pass from the inlet region 250 to the passageway 252. Finally, the trailing end 274 is configured to mountably receive the button 238 that otherwise has an outer diameter greater than that of the coupler body 234 at the passageway 252. Thus, upon final assembly, the button 238 prevents overt insertion of the plunger 236 into the coupler body 234.

As best shown in FIG. 6, the components 256-262 are assembled to the inlet region 250 of the coupler body 234 as previously described. In particular, the grip 256 is mounted to the ring 258 that is otherwise secured to the coupler body 234. The O-ring 282 and the button 238 are assembled to the plunger 236 as previously described. The leading end 270 of the plunger 236 is then inserted into the coupler body 234 via the passageway 252. In this regard, the plunger 236 is slidably received within the coupler body 234, and is movable between a retracted position (shown in FIG. 6) and an insertion position. With respect to the orientation of FIG. 6, the insertion position entails sliding the plunger 236 downwardly such that the leading end 270 of the plunger 236 is positioned within the inlet region 250 of the coupler body 234. Regardless, with the supply tube 46 fluidly coupled to the outlet port 254, the coupler body 234 is fluidly connected to the outlet 232 otherwise associated with the liquid reservoir 26 (FIG. 1). In particular, the outlet 232 is forced into the grip 256 (mounted at the inlet region 250 of the coupler body 234). The plunger 236 is maneuvered to the insertion position such that the tip 276 pierces through a membrane (not shown) preferably covering the outlet 232. Notably, in the insertion position, the O-ring 262 seals the plunger 236 relative to the coupler body 234 such that liquid from the reservoir 26 cannot unexpectedly flow to the outlet port 254, and thus to the supply tube 46.

The plunger 236 is then transitioned to the retracted position (FIG. 6) in which the plunger 236 no longer engages the O-ring 262. As a result, liquid is allowed to flow (via a spacing between the fingers 275 and the neck 277) to the outlet port 254, and thus to the supply tube 46. In this regard, the handle 240 provides a convenient surface for a user to grasp the supply valve device 230 and effectuate desired movement of the plunger 236. In the retracted position, a user can then initiate liquid flow from the reservoir 26 (FIG. 1) to the mop handle assembly 22 (FIG. 1) via the supply tube 46.

An additional feature associated with the preferred supply valve device 230 described above is that in the retracted position, the grip 256 cannot easily be disengaged from the outlet 232 with the plunger 236 in the retracted position. More particularly, where an attempt is made to pull the outlet 232 outwardly from the inlet region 250 of the coupler body 234, the arms 264 of the grip 256 are forced radially inwardly via interaction between the feet 266 and the ring 258. As a result, a pulling force placed on the outlet 234 essentially serves to “tighten” the connection between the grip 256 and the outlet 232. Thus, the preferred supply valve device 230 prevents unexpected disconnection of the outlet 232 from the coupler body 234 during use. Instead, the user must make a conscious effort to “lock” the grip 256 and the ring 258 relative to the coupler body 234 before effectuating removal of the outlet 232. In one preferred embodiment, this desired relationship is achieved via a shoe 284 (FIG. 1) provided with the cart 28 (FIG. 1). In general terms, to disconnect the outlet 232 from the grip 256, the outlet 232 is placed with a slot 286 formed by the shoe 284, with the supply valve device 230 resting on top of the shoe 284. As the outlet 232 is then pulled away (downwardly relative to the orientation of the FIG. 1) from the supply valve device 230, the grip 256 is prevented from moving relative to the coupler body 234 via contact with the shoe 284. The outlet 232 can then be withdrawn from the grip 256. It will be recognized, however, that the supply valve device 230 can assume a wide variety of forms known in the art different from that described with respect to FIGS. 5 and 6.

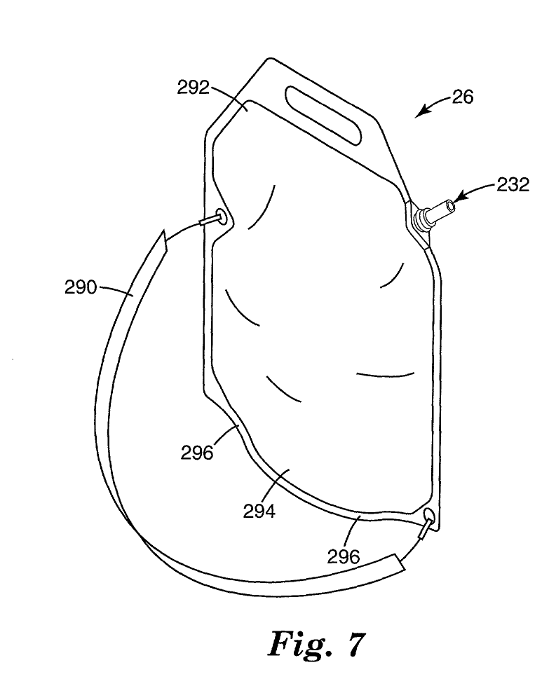

As previously described, the mop handle assembly 22 is preferably configured to dispense liquid from the liquid reservoir 26 (FIG. 1) without the introduction of air upstream of the orifice(s) 68 (FIG. 3A). In this regard, the mop handle 22 relies upon gravity feeding of the liquid from the reservoir 26. Preferably, the liquid reservoir 26 is collapsible to ensure a constant supply of liquid to the mop handle assembly 22. With this in mind, FIG. 7 depicts one preferred embodiment of the liquid reservoir 26 in the form of a collapsible bag including the outlet 232 and a handle 290 (preferably in the form of a strap). As a point of reference, FIG. 7 depicts the reservoir 26 in an upright position, whereby a top 292 and a bottom 294 are defined. The outlet 232 is positioned adjacent the top 292 and is fluidly connected to an interior of the reservoir 26. Conversely, the strap 290 is attached to, or otherwise associated with, the reservoir 26 adjacent the bottom 294. In this regard, the bottom 294 preferably forms pleats 296 (referenced generally) that facilitate maintaining the reservoir 26 in an upright position when the reservoir 26 contains a volume of liquid. Alternatively, the reservoir can assume other non-pleated configurations that promote maintaining the reservoir 26 in the upright position of FIG. 7. The liquid reservoir 26 can conveniently be stabilized in the upright position to facilitate connection of the outlet 232 to the supply tube 46 as previously described. During use, however, the reservoir 26 is preferably inverted to ensure gravity flow of the contained liquid to the outlet 232. The preferred location of the strap 290 facilitates this orientation, as the strap 290 is conveniently placed over a user's shoulder during use, with the location of the strap 290 ensuring that the reservoir 26 is inverted. Alternatively, the strap 290 can assume a variety of other handle-like forms that facilitate carrying of the reservoir 26 by a user (for example, a clip for fastening to a user's belt, a carrying handle, and the like).

The mop handle assembly and related kit of the present invention provides a marked improvement over previous designs. The mop handle assembly is simple to use, and simulates the natural look and feel of standard mop handles. Further, the various fluid connections provided by the mop handle assembly and related kit components greatly minimizes the opportunity for inadvertent liquid spillage while providing consistent control over liquid dispensement.

Although the present invention has been described with reference to preferred embodiments, workers skilled in the art will recognize that changes can be made in form and detail without departing from the spirit and scope of the present invention. For example, while the handle assembly has preferably been described as being used for mop-like applications, the handle assembly can alternatively be used in a variety of other applications not otherwise entailing use of a mop or similar type implement. Also, the mop handle assembly can be longer for floor finishing/cleaning applications, or shorter for confined area use (for example cleaning toilets or urinals). Further, the various seal components described with respect to the preferred embodiment mop handle assembly can be altered in terms of number and location. For example, the preferred lip seals associated with the downstream housing can be carried by the plunger instead of the sleeve and bottom components thereof. Alternatively, although the liquid reservoir has preferably been described as being a collapsible bag, the mop handle assembly is equally useful with other reservoir configurations, such as a vented jug

What is claimed is:

1. A handle assembly for dispensing liquid from a remote liquid reservoir, comprising:
a handle defining an upper end, a lower end and an internal passage;
a valve system including:
an upstream housing associated with the upper end of the handle and defining an inlet adapted to be fluidly connected to a remote liquid reservoir,
a dispensing assembly associated with the lower end of the handle and including a plunger defining a central passage fluidly connected to at least one orifice;
a delivery tube disposed within the handle and fluidly connecting the upstream housing and the plunger; and
an actuator assembly biasing the valve system toward a closed position in which the orifice is sealed relative to an exterior of the dispensing assembly, and configured to allow selective actuation of the valve system to an open position in which the orifice is not sealed relative to an exterior of the dispensing assembly;
wherein the valve system is configured to permit flow of liquid from the upstream housing to the orifice in the open position without introduction of air upstream of the orifice.

2. The handle assembly of claim 1, further comprising:
a supply tube defining a first end and a second end, the first end adapted to be fluidly connected to a remote liquid reservoir and the second end fluidly coupled to the inlet of the housing.

3. The handle assembly of claim 2, further comprising:
a release valve assembly couplable to the first end of the supply tube, the valve assembly adapted for fluidly connecting the supply tube to a remote liquid reservoir and to seal the first end of the supply tube when disconnected from the remote liquid reservoir.

4. The handle assembly of claim 1, wherein the delivery tube rigidly connects the housing and the plunger such that axial movement of the housing results in axial movement of the plunger.

5. The handle assembly of claim 1, wherein the entire delivery tube is disposed within the handle in at least the closed position.

6. The handle assembly of claim 1, wherein the actuator assembly slidably connects the housing to the top end of the handle, such that the housing is axially slidable between the closed position and the open position.

7. The handle assembly of claim 6, wherein the actuator assembly includes:
a collet connected to the outlet of the upstream housing;
a sleeve slidably receiving the collet, the sleeve being connected to the top end of the handle; and
a spring disposed within the sleeve and in contact with the collet;
wherein the compression spring biases the collet toward the closed position.

8. The handle assembly of claim 1, wherein the dispensing assembly further includes:
a downstream housing within which the plunger is slidably received, the downstream housing defining a bottom end;
wherein the valve system is adapted such that in the closed position, the orifice is retracted relative to the bottom end of the downstream housing, and in the open position at least a portion of the orifice is extended beyond the bottom end for distributing liquid.

9. The handle assembly of claim 8, wherein the dispensing assembly further includes:
a first seal sealing the downstream housing and the plunger upstream of the orifice in the closed position; and
a second seal sealing the downstream housing and the plunger downstream of the orifice in the closed position;
wherein upon transition of the valve system to the open position, at least a portion of the orifice extends downstream of the second seal.

10. The handle assembly of claim 9, wherein the first and second seals are lip seals oriented to facilitate transition of the valve assembly from the closed position to the open position.

11. The handle assembly of claim 1, wherein the plunger forms two orifices.

12. The handle assembly of claim 1, wherein the two orifices are circumferentially aligned at opposite sides the plunger.

13. The handle assembly of claim 12, wherein during use, the handle is oriented to define a forward side and a rearward side, and further wherein one of the two orifices is substantially aligned with the forward side and an other of the two orifices is substantially aligned with the rearward side.

14. The handle assembly of claim 1, further comprising:
a mop head-coupling device associated with the handle adjacent the lower end for selectively receiving a mop head.

15. The handle assembly of claim 14, wherein the mop head coupling device includes a ring-shaped capture device rotatably secured about the handle, the capture device adapted to receive a mop head frame configured to maintain a mop head.

16. The handle assembly of claim 15, wherein the mop head frame is configured to maintain a mop head selected from the group consisting of a string mop, a flat mop, a sponge mop, a squeegee, and a broom.

17. The handle assembly of claim 15, wherein the mop head frame includes a shoulder portion forming an axial passage and at least one radial aperture fluidly connected to the axial passage, and further wherein upon final assembly to the mop head coupling device and transition of the valve assembly to the open state, the axial passage is positioned to receive the plunger such that liquid flowing from the orifice is released through the aperture.

18. A kit comprising:
a handle assembly including:
a handle defining an upper end, a lower end and an internal passage,
a supply tube defining a first end and a second end,
a valve system including:
an upstream housing associated with the upper end of the handle and defining an inlet adapted to be fluidly connected to a remote liquid reservoir,
a dispensing assembly associated with the lower end of the handle and including a plunger defining a central passage fluidly connected to at least one orifice,
a delivery tube disposed within the handle and fluidly connecting the upstream housing and the plunger,
an actuator assembly biasing the valve assembly toward a closed position in which the orifice is sealed relative to an exterior of the dispensing assembly and configured to allow selective actuation of the valve assembly to an open position in which the orifice is not sealed relative to an exterior of the dispensing assembly; and
a liquid supply reservoir fluidly connected to the first end of the supply tube, the liquid supply reservoir being positionable remote of the handle;
wherein the valve system is configured to permit flow of liquid from the liquid supply reservoir to the orifice in the open position without introduction of air upstream of the orifice.

19. The kit of claim 18, wherein the liquid supply reservoir includes a flexible, collapsible bag containing a volume of liquid.

20. The kit of claim 19, wherein the kit is configured such that upon final assembly, the valve system is sealed in the closed state.

21. The kit of claim 20, wherein the kit is configured such that upon final assembly, the valve system is sealed in the open position except at the orifice.

22. The kit of claim 19, wherein the bag includes an outlet and the handle assembly further includes a supply valve device connected to the first end of the supply tube for fluidly coupling the supply tube to the outlet, the supply valve device configured to be sealed when not connected to the outlet.

23. The kit of claim 19, wherein the liquid supply reservoir further includes a handle associated with the bag and the bag includes an outlet for allowing release of the liquid from the bag, and further wherein the handle is connected to the bag such that during use, the handle is carried by a user with the outlet extending below the bag.

24. The kit of claim 19, wherein the bag includes a bottom configured to support the bag in an upright position, and an outlet positioned opposite the bottom of the bag.

25. The kit of claim 18, wherein the delivery tube rigidly connects the housing and the plunger such that axial movement of the housing dictates a corresponding axial movement of the plunger.

26. The kit of claim 18, wherein an entirety of the delivery tube is disposed within the handle in at least the closed position.

27. The kit of claim 18, wherein the actuator assembly includes:
a collet connected to the outlet of the upstream housing;
a sleeve slidably receiving the collet, the sleeve being connected to the top end of the handle; and
a spring disposed within the sleeve and in contact with the collet;
wherein the compression spring biases the collet toward the closed position.

28. The kit of claim 18, wherein the dispensing assembly further includes:
a downstream housing within which the plunger is slidably received, the downstream housing defining a bottom end;
wherein the valve system is adapted such that in the closed position, the orifice is retracted relative to the bottom end of the downstream housing and in the open position at least a portion of the orifice is extended beyond the bottom end for distributing liquid.

29. The kit of claim 28, wherein the dispensing assembly further includes:
a first seal sealing the downstream housing and the plunger upstream of the orifice in the closed position; and
a second seal sealing the downstream housing and the plunger downstream of the orifice in the closed position;
wherein upon transition of the valve system to the open position, at least a portion of the orifice extends downstream of the second seal.

30. The kit of claim 18, wherein the plunger forms two, circumferentially aligned orifices at opposite sides of the plunger.

31. The kit of claim 18, wherein the handle assembly is configured to maintain a mop head selected from the group consisting of a string mop, a flat mop, a sponge mop, a squeegee, and a broom.

32. A liquid reservoir for containing a liquid useful for surface finishing or cleaning applications, the reservoir used in conjunction with a handle assembly adapted to selectively dispense liquid from an orifice without introduction of air upstream of the orifice, the reservoir comprising:
a flexible bag defining a top and a bottom, the bottom configured to maintain the bag in an upright position;
an outlet fluidly connected to an interior of the bag and positioned adjacent the top; and
a handle associated with the bag adjacent the bottom.

33. The reservoir of claim 32, wherein the bag is adapted for being fluidly connected to the mop handle assembly in the upright position and to deliver liquid to the handle assembly in an inverted position.

34. The reservoir of claim 32, wherein the bag is collapsible.
